(19) United States
(12) Patent Application Publication
(10) Pub. No.: US 2010/0193097 A1
(43) Pub. Date: Aug. 5, 2010

(54) ELASTIC SHEAR BAND WITH CYLINDRICAL ELEMENTS

(76) Inventors: Jared Hahn McNier, Cowpens, SC (US); Joseph Scott Newman, Mt. Pleasant, SC (US); Joshua Stuart Reynolds, Walterboro, SC (US); David Thomas Stowe, Clemson, SC (US); Zachary James Taylor, Greenville, SC (US); Ronald Hobart Thompson, Greenville, SC (US)

Correspondence Address: MICHELIN NORTH AMERICA, INC.;INTELLECTUAL PROPERTY DEPARTMENT, MARC BLDG 31-2, 515 MICHELIN ROAD, GREENVILLE, SC, 29605, US

(21) Appl. No.: 12/667,105

(22) PCT Filed: Jun. 6, 2008
(86) PCT No.: PCT/US2008/066082

§ 371 Date: Dec. 29, 2009

Related U.S. Application Data
(60) Provisional application No. 60/947,093, filed on Jun. 29, 2007.

(51) Int. Cl. B60C 7/00; B60B 1/00

(52) U.S. Cl. 152/311

(57) ABSTRACT

A shear band that may be used as part of a structurally supported wheel is provided. More particularly, a shear band constructed from resilient, cylindrical elements attached between inextensible members is described. In certain embodiments, the shear band may be constructed entirely or substantially without elastomeric or polymer-based materials. Multiple embodiments are available including various arrangements of the cylindrical elements between the members as well as differing geometries for the cylindrical elements.

### TECHNICAL FIELD OF THE INVENTION

The present invention relates to a shear band that may be used as part of a structurally supported wheel. More particularly, a shear band constructed from resilient, cylindrical elements attached between circumferential members is provided. In certain embodiments, the shear band may be constructed entirely or substantially without elastomeric or polymer-based materials, which allows for application in extreme environments.

### BACKGROUND OF THE INVENTION

The use of structural elements to provide load support in a tire without the necessity of air pressure has been previously described. For example, U.S. Pat. No. 6,769,465 provides a resilient tire that supports a load without internal air pressure. This tire includes a ground contacting tread portion, a reinforced annular member, and sidewall portions that extend radially inward from the tread portion. By way of further example, U.S. Pat. No. 7,201,194 provides a structurally supported non-pneumatic tire that includes a ground contacting tread portion, a reinforced annular element disposed radially inward of the tread portion, and a plurality of web spokes extending transversely across and radially inward from the reinforced annular element and anchored in a wheel or hub. For each of these references, the constructions described are particularly amenable to the use of elastomeric materials including rubber and other polymeric materials. The use of such materials has certain limitations, however. For example, extreme temperatures levels and large temperature fluctuations can make such elastomeric materials unsuitable for certain applications. Accordingly, constructions that can be created in whole or in part with non-elastomeric materials would be advantageous. Also, constructions from materials such as carbon-based elements may also result in reduced weight and lower materials costs. These and other advantages are provided by certain exemplary embodiments of the present invention.

### THE SUMMARY OF THE INVENTION

Objects and advantages of the invention will be set forth in part in the following description, or may be obvious from the description, or may be learned through practice of the invention.

In one exemplary embodiment of the invention, a shear band is provided that defines axial, radial, and circumferential directions. The shear band includes an outer member extending along the circumferential direction, an inner member extending along the circumferential direction, and a plurality of resilient, cylindrical elements connected with the outer and inner members and each extending between the members along the radial direction. The arrangement of cylindrical elements between the members may be varied. For example, in one variation, the cylindrical elements are arranged into multiple, overlapping rows along the axial direction. The overlapping rows are positioned about the circumferential direction between the outer and inner inextensible members. In another variation, the cylindrical elements are arranged into a series of axially-aligned, non-overlapping rows and are positioned about the circumferential direction between the members. The cylindrical elements may be constructed as circular shapes; however, elliptical or oblong constructions may also be used.

Each cylindrical element defines an axis. The axis of the cylindrical elements may be arranged in a manner that is parallel to the axial direction of the shear band, or the cylindrical elements may be arranged in non-parallel orientations. The cylindrical elements may be attached directly to the outer and inner members or may be attached to other components that are in turn connected with the outer and inner members. More specifically, a variety of different means may be used for connecting the cylindrical elements to the outer and inner inextensible members. The inner and outer inextensible members as well as the cylindrical elements may be constructed from a variety of different materials. Traditional elastomeric and polymer-based materials may be used. In addition, the present invention allows for the application of a variety of other materials including, for example, metal and/or carbon-fiber based materials.

In another exemplary embodiment, the present invention provides a wheel that defines axial, radial, and circumferential directions. The wheel includes a hub, a shear band, and a plurality of support elements connected between the hub and the shear band. The shear band includes an outer circumferential member extending along the circumferential direction at a radial position R₂, and an inner circumferential member extending along the circumferential direction at a radial position R₁. The ratio of R₁ to R₂ is about 0.8≦(R₁/R₂)<1. A plurality of substantially cylindrical elements are connected with the inner circumferential member and the outer circumferential member. In certain embodiments, the shear band has a shear efficiency of at least about 50 percent. In addition, other variations as previously described may also be applied.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1A is an exemplary embodiment of the present invention that includes a non-pneumatic wheel incorporating an embodiment of a shear band.

FIG. 1B is a perspective view of a section of the exemplary shear band of FIG. 1A taken at the location so identified in FIG. 1A.

FIG. 2A is another exemplary embodiment of the present invention that includes a non-pneumatic wheel incorporating an embodiment of a shear band.

FIG. 2B is a perspective view of a section of the exemplary shear band of FIG. 2A taken at the location so identified in FIG. 2A.

FIG. 2C is a cross-sectional view taken along lines 3-3 of the exemplary embodiment of FIG. 3A.

### DETAILED DESCRIPTION

Objects and advantages of the invention will be set forth in the following description, or may be apparent from the description, or may be learned through practice of the invention. Repeat use of reference characters throughout the present specification and appended drawings is intended to represent same or analogous features or elements of the invention.

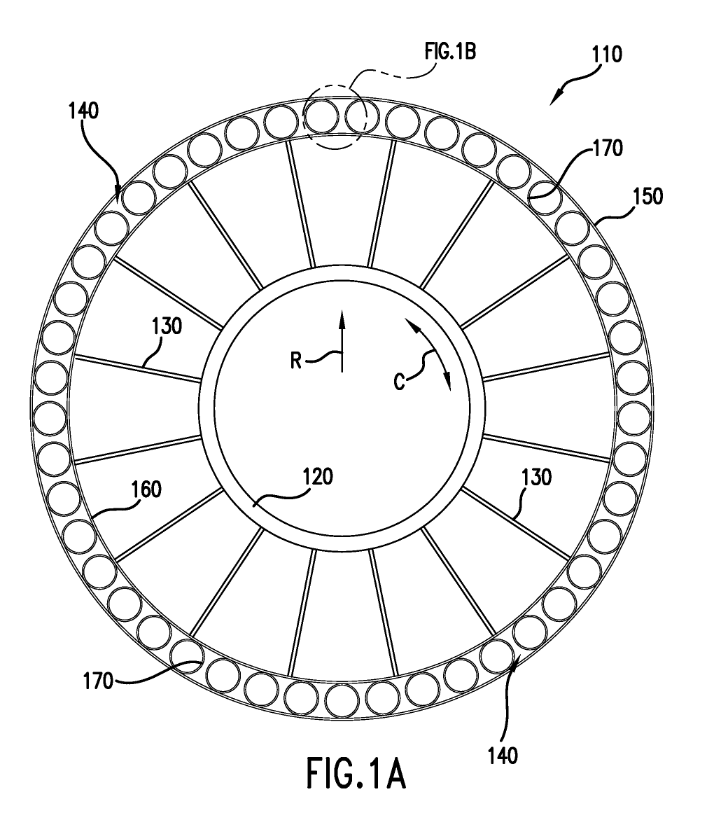

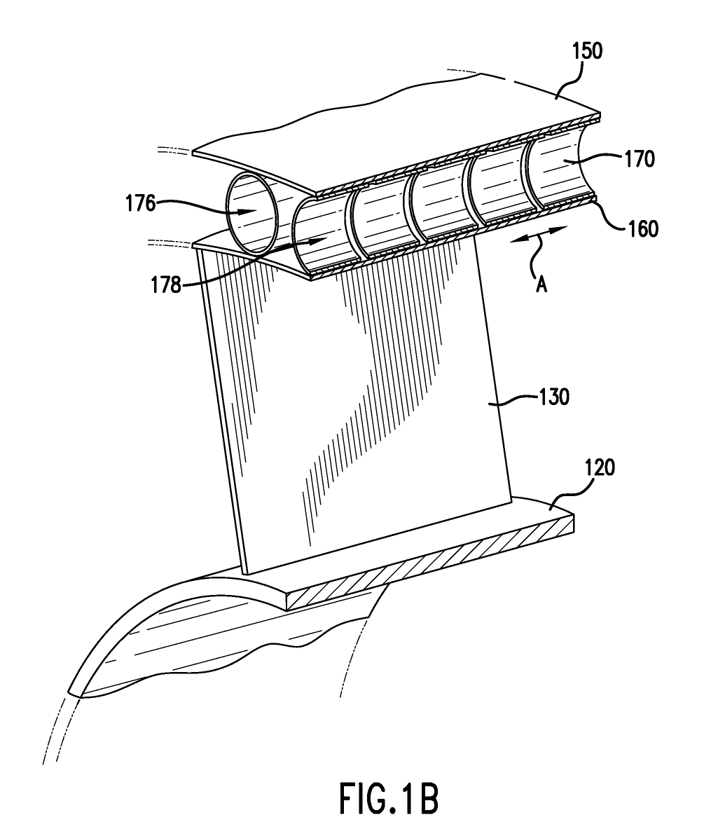

An exemplary embodiment of a wheel 110 according to the present invention is shown in FIG. 1A with a portion of wheel 110 being shown in FIG. 1B. Wheel 110 defines radial directions R, circumferential directions C (FIG. 1A), and axial directions A (FIG. 1B). Wheel 110 includes a hub 120 connected to a shear band 140 by multiple support elements 130. Shear band 140 includes multiple cylindrical elements 170 that are spaced circumferentially about shear band 140. Hub 120 provides for the connection of wheel 110 to a vehicle and may include a variety of configurations for connection as desired. For example, hub 120 may be provided with connecting lugs, holes, or other structure for attachment to a vehicle axle and is not limited to the particular configuration shown in FIG. 1A. Support elements 130 connect hub 120 to shear band 140 and thereby transmit the load applied to hub 120. As with hub 120, support elements 130 may take on a variety of configurations and are not limited to the particular geometries and structure shown in FIG. 1A. In addition, using the teachings disclosed herein, one of skill in the art will understand that tread or other features may be readily added to the outer circumferential surface 155.

Cylindrical elements 170 are positioned between an outer member 150 and an inner member 160. In one embodiment, for example, members 150 and 160 may be constructed from a metal element encircled as shown in FIG. 1A. By way of further examples, steel as might be used in the construction of springs, or carbon based filaments may also be utilized for the fabrication of members 150 and 160. While elastomeric materials can also be used, the utilization of non-elastomeric materials for members 150 and 160 provides for extreme temperature applications such as a polar or lunar environment where elastomeric materials may become too rigid or brittle. For example, shear bands (including wheels incorporating such members) capable of functioning at temperatures as low as 100 degrees Kelvin should be achievable where elastomeric constructions are avoided.

Focusing on FIGS. 1A and 1B, for this particular exemplary embodiment, cylindrical elements 170 are each constructed from a relatively short cylinder. Although shown as perfectly circular cylinders in the figures, other configurations may be used. For example, oval or elliptical configurations may be employed and “cylinder” or “cylindrical” as used herein encompasses these and other shapes for a cylinder that may not be perfectly circular and may have different relative lengths from that shown. As with members 150 and 160, cylindrical elements 170 may be constructed from a variety of relatively resilient, materials including again, for example, metal or carbon-based filaments, as well as elastomeric and polymer based materials where temperatures so allow. In addition, the present invention is not limited to cylindrical elements 170 having the relative widths along the axial direction that are shown in the figures. Instead, different widths may be use relative to the axial width of the cylindrical members 150 and 160. For example, whereas five cylindrical elements 170 are shown across the axial width of members 150 and 160, a different number of cylindrical elements 170 may be used with varying widths for the cylindrical elements 170. Furthermore, although cylindrical elements 170 may be positioned immediately adjacent to one another along the axial direction as shown in FIG. 3, larger gaps or spacing may also be used along the axial direction. Alternatively, elements 170 may be constructed to overlap as discussed with regard to another exemplary embodiment below.

FIG. 1B illustrates a perspective, sectional view of shear band 140. Notably, fasteners are not used in this exemplary embodiment. Instead, cylindrical elements 170 are connected directly to the circumferential, outer and inner members 150 and 160. By way of example, cylindrical elements 170 could be welded or adhered to members 150 and 160, or cylindrical elements 170 could be formed integrally with such members. Alternatively, various mechanical fasteners may be employed to connect cylindrical elements 170 as will be discussed below.

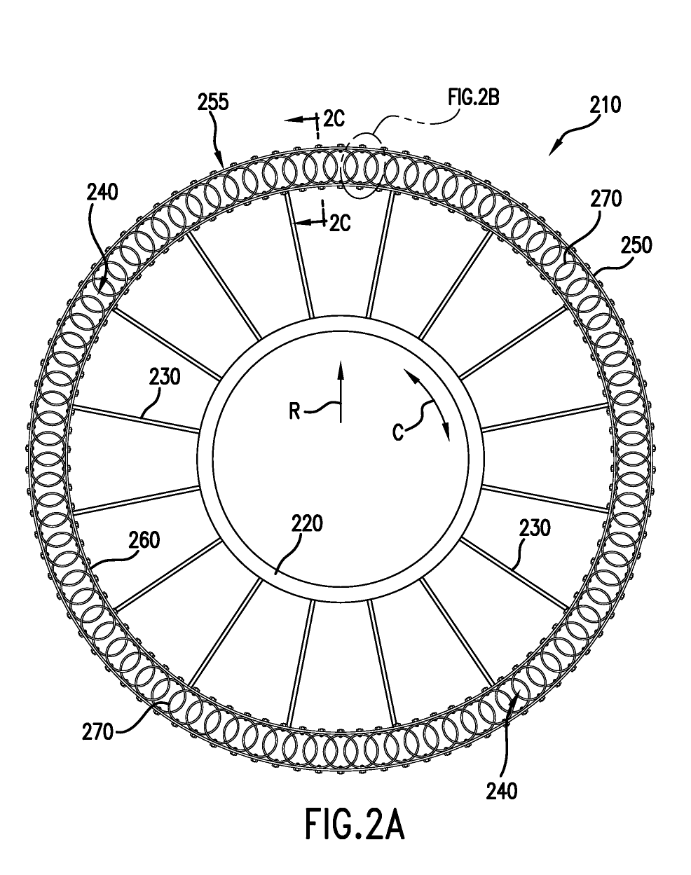

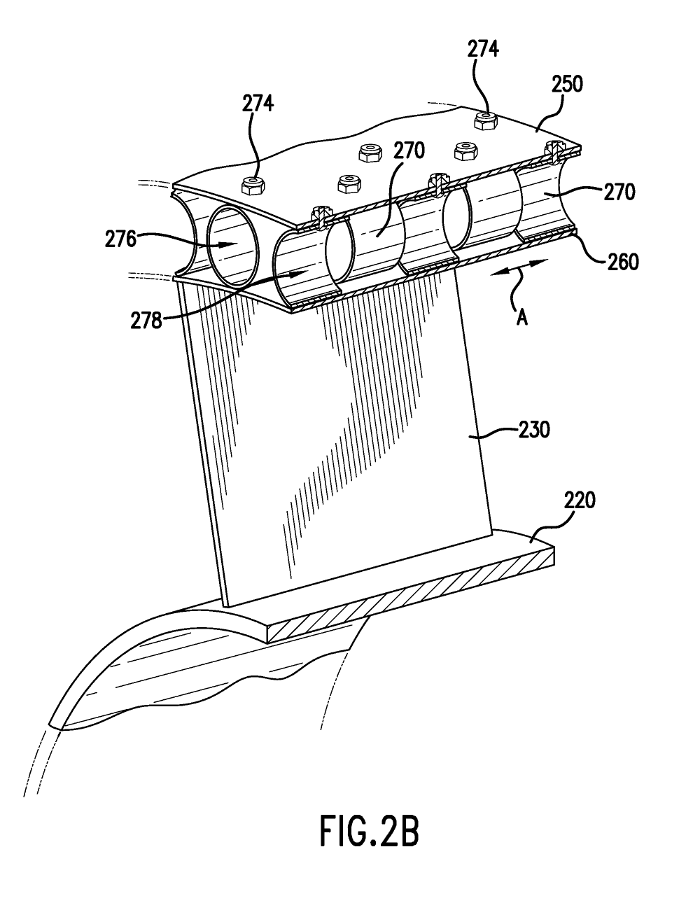

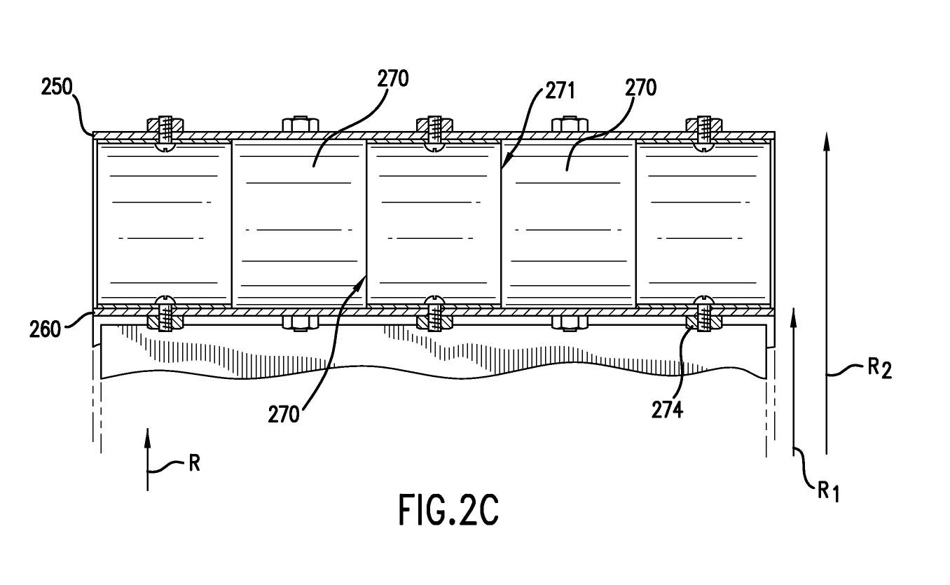

Turning now to FIGS. 2A, 2B, and 2C, cylindrical elements 270 are shown arranged in rows 276 and 278 (FIG. 2) that are overlapping along the axial directions A. Again, however, the present invention includes multiple other arrangements of cylindrical elements 270 between members 250 and 260. For example, cylindrical elements 270 could be random, parallel, staggered, offset, overlapping rows, non-overlapping rows, aligned in rows that are not parallel to axial directions A, and so forth. As will be discussed later, cylindrical elements 270 provide a shear layer during operation that may be achieved by a variety of geometries and configurations that are within the scope of the present invention. Additionally, the axis of each cylindrical element 270 is shown as basically parallel to axial directions A. However, orientations that are not parallel may also be employed. As such, the configuration of FIGS. 2A through 2C emphasizes yet another exemplary embodiment of the present invention. Again, using the teachings disclosed herein, one of skill in the art will understand that multiple constructions and geometries may be used to provide the cylindrical elements between outer and members to create a shear band according to the present invention.

FIG. 2B illustrates a perspective, sectional view of shear band 240, and FIG. 2C illustrates a cross-section. Notably, fasteners 274 are used in this exemplary embodiment. More specifically, cylindrical elements 270 are secured by fasteners 274 that extend through the outer and inner members 250 and 260. It should be understood that multiple other types of fasteners or techniques may be used to secure the position of cylindrical elements 270, and the present invention is not limited to the use of fasteners 274. More specifically, for connecting cylindrical elements 270 to members 250 and 260, constructions may include rivets, epoxy, or molding as unitary constructions as previously discussed.

Although not limited thereto, the shear band of the present invention has particular application in the construction of wheels including, but not limited to, non-pneumatic tires and other wheels that do not require pneumatic pressure for structural support. For example, in a pneumatic tire, the ground contact pressure and stiffness are a direct result of the inflation pressure and are interrelated. However, a shear band of the present invention may be used to construct a wheel or tire that has stiffness properties and a ground contact pressure that are based on their structural components and, advantageously, may be specified independent of one another. Wheels 110 and 210 provide examples of such constructions. In addition, and advantageously, because the present invention includes structures and geometries for a shear band construction that are not limited to elastomeric (e.g. rubber) or polymer-based materials, the present invention provides for the construction of a wheel that may be used in extreme temperature environments. As used herein, extreme temperature environments includes not only environments experiencing temperatures that would be unacceptable for elastomeric or polymer-based materials but also includes environments where large temperature fluctuations may occur.

Returning to FIG. 1A, for example, it will be understood from the figures and description provided above that outer member 150 is longer circumferentially than the inner member 160 and both are relatively inextensible. Accordingly, in operation under an applied load to wheel 110, the shearing of cylindrical elements 170 between the members 150 and 160 allows the shear band 140 to deform to provide a greater contact area with the travel surface (e.g. ground).

More specifically, cylindrical elements 170 collectively act as a shear layer having an effective shear modulus G_{eff}. The relationship between this effective shear modulus G_{eff} and the effective longitudinal tensile modulus Eᵢₘ of the outer and inner members 150 and 160 controls the deformation of the shear band 140 under an applied load. When the ratio of Eᵢₘ/G_{eff} is relatively low, deformation of the shear band under load approximates that of the homogeneous member and produces a non-uniform contact pressure with the travel surface. However, when the ratio Eᵢₘ/G_{eff} is sufficiently high, deformation of the annular shear band 140 under load is essentially by shear deformation of the shear layer (i.e. cylindrical elements 170) with little longitudinal extension or compression of the inextensible members 150 and 160). Perfectly inextensible members 150 and 160 would provide the most efficient structure and maximize the shear displacement in the shear layer. However, perfect inextensibility is only theoretical: As the extensibility of members 150 and 160 is increased, shear displacement will be reduced as will now be explained in conceptual terms below.

In the contact region, the inner member 160, located at a radius R₁, is subjected to a tensile force. The outer member 150, located at a radius R₂, is subjected to an equal but opposite compressive force. For the simple case where the outer and inner members 150 and 160 have equivalent circumferential stiffness, the outer member 150 will become longer by some strain, e, and the inner member 160 will become shorter by the some strain, −e. For a shear layer having a thickness h, this leads to a relationship for the Shear Efficiency of the bands, defined as:

$$Shear Efficiency = ( 1 - \frac{e ( R 2 + R 1 )}{h} ) \qquad ( 1 )$$

It can be seen that for the perfectly inextensible members, the strain e will be zero and the Shear Efficiency will be 100%.

The value of the strain e can be approximated from the design variables by the equation below:

$$e = \frac{{G}_{eff} {L}^{2}}{8 {R}_{2} Et} \qquad ( 2 )$$

For example, assume we have a proposed design with the following values:
h=10 mm (radial distance between bands 50 and 60)
G_{eff}=4 N/mm2 (effective shear stiffness between the bands)
L=100 mm (contact patch length necessary for design load)
R₂=200 mm (radial distance to outer member)
R₁=190 mm (radial distance to inner member)
E=20,000 N/mm2 (tensile modulus for both members 150 and 160)
t=0.5 mm (thickness for both members 150 and 160)
   Calculating for e using E:

$$e = \frac{( 10 ) {( 100 )}^{2}}{8 ( 200 ) ( 20 , 000 ) ( 0.5 )} = 0.0025$$

The shear efficiency can then be calculated as:

$$Shear efficiency = 1 - \frac{0.0025 ( 190 + 200 )}{10} = 0.9025 \qquad ( 3 )$$

Thus, the efficiency in this case is approximately 90%.

The above analysis assumes that outer and inner members 150 and 160 have identical constructions. However, the thickness and/or the modulus of members 150 and 160 need not be the same. Using the principles disclosed herein, one skilled in the art can readily calculate the strains in members 150 and 160 and then calculate the shear efficiency, using the above approach. A Shear Efficiency of at least 50% should be maintained to avoid significant degradation of the contact pressure with the travel surface. Preferably, a Shear Efficiency of at least 75% should be maintained.

Accordingly, as sufficient Shear Efficiency is achieved, contact pressure with the travel surface becomes substantially uniform. In such case, an advantageous relationship is created allowing one to specify the values of shear modulus G_{eff} and the shear layer thickness h for a given application:

P_{eff}*R₂=G_{eff}*h (4)

### Where:

P_{eff}=predetermined ground contact pressure
G_{eff}=effective shear modulus of columnar elements 170 within members 150 and 160
h=thickness of the shear layer—i.e. radial height of posts 170
R₂=radial position of the outer member 150
   As one of skill in the art will appreciate using the teachings disclosed herein, the above relationship is useful in the design context because frequently P_{eff} and R₂ are known—leaving the designer to optimize G_{eff} and h for a given application.

The behavior of shear layer 140 and, more specifically, the effective shear modulus G_{eff} may be modeled using an approach as will now be described. Assuming that inextensible member 150, inextensible member 160, and cylindrical elements 170 are each uniform in physical properties along the axial directions A and that cylindrical elements 170 deform predominantly in shear along circumferential directions C, wheel 110 can be modeled as a wire-based structure (i.e. beam and truss elements) with a two-dimensional planar model that is one unit (e.g. one mm) in width along the axial directions A. As part of such approach, a single cylindrical element is modeled as a single cylinder that is constrained at one point (node) and then subjected to a non-rotational, tangential displacement at a point (node) on the opposite side of the cylinder (i.e. the nodes are located on the respective ends of a diameter to the two-dimensional, planar model of the cylinder). Using this model, the reaction force can be calculated and used to determine the equivalent effective shear modulus as follows:

G=τ/γ (5)

### Where:

G=shear modulus, in N/mm²,
τ=shear stress, in N/mm²,
γ=shear angle, in radians.
   The shear stress τ is calculated using the following familiar equation:

τ=F/A (6)

### Where:

F=reaction force computed by finite element analysis on the single cylinder model described above, in N,
A=tributary area in the circumference and depth directions for one cylinder, in mm².

Limiting the finite element model to 1.0 mm in depth as mentioned above, area A can be calculated in terms of the radius of the annular member and the number of cylinders using the following equation:

A=2πR/N (7)
where:
R=radius of the annular member, in mm,
N=number of cylinders.
   The shear angle is determined in terms of the predefined displacement imposed on the cylinder and the diameter of the cylinder, as follows:

γ=tan⁻¹(δ/h) (8)
where:
δ=displacement imposed at the top node of the cylinder, in mm,
h=diameter of a cylinder, in mm.

Combining Equations 2 to 5, the effective shear modulus is given by the following equation:

G=FN/(2πR tan⁻¹(δ/h)) (9)

The reaction force F depends on the material properties of the cylinder (i.e. Young's modulus E and Poisson's ratio v) and the thickness of the cylinder t. The designer of a shear band can therefore choose design variables E, v, t, h, and N, select a displacement δ, and then compute the reaction force F by finite element analysis of a single cylinder (using the model just described above) in order to obtain the desired effective shear modulus.

Using this approach, modeling of a two dimensional wheel 110 having a construction similar to FIG. 1 was undertaken as will be understood by one of skill in the art using the teachings disclosed herein. The geometry of wheel 110 was defined into wire based structures having the components of cylindrical elements 170, outer and inner members 150 and 160 (each modeled using Timoshenko quadratic beam finite elements), support elements 130 (modeled as a linear truss element with no compression), and a ground represented as a rigid wire with a reference point. Boundary conditions included the radially inner end of each support element 130 constrained in displacement, and the interaction between the ground and outer member 150 was defined as a contact with frictionless tangential behavior and hard contact normal behavior. During simulation, the ground was moved upward gradually by a predetermined distance. As will be understood by one of skill in the art using the teachings disclosed herein, commercial software sold under the name Abaqus/CAE (Version 6.6-1) was used to conduct the finite element analysis and the following results were obtained:

TABLE ONE

| | | | | | Shear |
|---|---|---|---|---|---|
| Displacement d | Thickness t | Diameter D | Reaction force F | Area (depth = 1 mm), A | Modulus G |
| (mm) | (mm) | (mm) | (N) | (mm\hat{ }2) | (MPa) |
| 20 | 0.5 | 40 | 8.21 | 40 | 0.44 |
| 20 | 1 | 40 | 57.1 | 40 | 3.08 |
| 20 | 1.5 | 40 | 212.2 | 40 | 11.44 |
| 20 | 2 | 40 | 523.3 | 40 | 28.22 |
| 20 | 0.5 | 60 | 2.22 | 60 | 0.11 |
| 20 | 1 | 60 | 17.7 | 60 | 0.92 |
| 20 | 1.5 | 60 | 59.8 | 60 | 3.10 |
| 20 | 2 | 60 | 141.4 | 60 | 7.32 |
| 20 | 0.5 | 48.26 | 4.43 | 48.26 | 0.23 |
| 20 | 1 | 48.26 | 35.5 | 48.26 | 1.87 |
| 20 | 1.5 | 48.26 | 119.5 | 48.26 | 6.30 |
| 20 | 2 | 48.26 | 283 | 48.26 | 14.93 |
| | | | | Area is larger to | |
| | | | | account for space | |
| | | | | between tubes | |
| 20 | 0.5 | 48.26 | 4.43 | 55 | 0.23 |
| 20 | 1 | 48.26 | 35.5 | 55 | 1.85 |
| 20 | 1.5 | 48.26 | 119.5 | 55 | 6.23 |
| 20 | 2 | 48.26 | 283 | 55 | 14.75 |

By way of example, the results indicate that the effective shear modulus G_{eff} increases as the thickness t of the cylindrical elements 170 increases and decreases as the diameter of the cylindrical elements 170 increases. More importantly, a method whereby a designer can develop an acceptable shear modulus G_{eff} for a shear band constructed according to the present invention is provided.

Finally, it should be noted that advantages of the present invention are principally obtained where the relative radial distance between the inner and outer members fall within a certain range. More specifically, preferably the following relationship is constructed:

0.8≦(R₁/R₂)<1 (10)

where:

R₂=radial position of the outer member (e.g. the distance to the outer member from the axis of rotation or focus of the radius defined by such member) (see FIG. 2C)

R₁=radial position of the inner member (e.g. the distance to the inner member from the axis of rotation or focus of the radius defined by such member) (see FIG. 2C)

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A shear band defining axial, radial, and circumferential directions, the shear band comprising:
an outer member extending along the circumferential direction;
an inner member extending along the circumferential direction; and
a plurality of resilient, cylindrical elements connected with said outer and inner members and each extending between said members along the radial direction.

2. A shear band as in claim 1, wherein said plurality of cylindrical elements are arranged into multiple, overlapping rows along the axial direction, said overlapping rows being positioned about the circumferential direction between said outer and inner inextensible members.

3. A shear band as in claim 1, wherein each of said plurality of cylindrical elements define an axis that is parallel to the axial direction.

4. A shear band as in claim 1, wherein each of said plurality of cylindrical elements are attached directly to said outer and inner inextensible members.

5. A shear band as in claim 1, wherein said outer and said inner members comprise metal members encircled along the circumferential direction.

6. A shear band as in claim 1, further comprising means for connecting said plurality of cylindrical elements to said outer member.

7. A shear band as in claim 6, further comprising means for connecting said plurality of cylindrical elements to said inner member.

8. A shear band as in claim 1, wherein said shear band has a shear efficiency of at least about 50 percent.

9. A shear band as in claim 1, wherein said plurality of cylindrical elements are substantially circular in shape.

10. A wheel comprising the shear band of claim 1.

11. A wheel defining axial, radial, and circumferential directions, the wheel comprising:
a hub;
a shear band comprising
an inextensible, outer circumferential member extending along the circumferential direction at a radial position R₂;
an inextensible, inner circumferential member extending along the circumferential direction at a radial position R₁, wherein a ratio of R₁ to R₂ is about 0.8≦(R₁/R₂)<1;
a plurality of substantially cylindrical elements, each connected with said inner circumferential member and said outer circumferential member; and
a plurality of support elements connecting said hub and said inner circumferential member of said shear band.

12. A wheel as in claim 11, wherein said plurality of cylindrical elements are arranged into multiple, offset rows along the axial direction, said off-set rows being positioned about the circumferential direction between said outer and inner circumferential members.

13. A wheel as in claim 11, wherein each of said plurality of cylindrical elements define an axis that is parallel to the axial direction.

14. A wheel as in claim 11, wherein each of said plurality of cylindrical elements are attached directly to said outer and inner circumferential members.

15. A wheel as in claim 11, wherein said outer and said inner circumferential members comprise metal members encircled along the circumferential direction.

16. A wheel as in claim 11, further comprising means for connecting said plurality of cylindrical elements to said outer circumferential member.

17. A wheel as in claim 16, further comprising means for connecting said plurality of cylindrical elements to said inner circumferential member.

18. A wheel as in claim 11, wherein said shear band has a shear efficiency of at least about 50 percent.

19. A wheel as in claim 11, wherein said plurality of cylindrical elements are substantially circular in shape.
